(19) United States
(12) Patent Application Publication
(10) Pub. No.: US 2011/0173058 A1
(43) Pub. Date: Jul. 14, 2011

(54) Consumer credit circuit

(76) Inventor: Hendrik Geert Pieter van Arkel, Strohalm (NL)

(21) Appl. No.: 12/657,040

(22) Filed: Jan. 13, 2010

(51) Int. Cl. G06Q 40/00; G06Q 30/00

(52) U.S. Cl. 705/14.17; 705/37; 705/34; 705/38

(57) ABSTRACT

The present invention provides a system that is wholly compatible with money and is usable for providing liquidity in a marketplace. The management system of the present invention uses standardized value claims in an administrative process to provide a source for settlement of obligations between parties and to extend the period in which cash is needed as a tool for commerce. This means of exchange can be established and used to introduce tools to have the circulation inside the management system or region optimized.

### BACKGROUND

These days we see in the Philippines and parts of Africa the realization of complex payments through a system based on the value of prepaid airtime minutes. While the calculation in values is still being done in terms of money, the actual transaction is done in claims on services or goods.

The world economy revolves around money changing hands for services and goods provided with the payment system for these exchanges dependent on the availability of money to facilitate exchange. However this means of exchange is scarce and typically charges interest and therefore not available to everybody that has business opportunities. In some cases, mutually dependent producers in an economic transaction solve this problem by settling their accounts with a net difference payable by the producer in deficit position. These modes of transaction almost always utilize an economic structure of one party owing or another party paying for goods and services. Sometimes a system incorporates a community of interested parties in a transaction that does not directly involve a debtor paying back to the creditor; however these systems are generally not money-linked but occur in a Barter-network.

A money-related system of a community requires capital capacity by the debtor or potential debtor to match or be leveraged in a transaction with a creditor or potential creditor. Both the lack of facilitation to exchange among each other as well as the interest costs for an organization, add to poverty especially in the low-income communities who are net-interest payers. The costs of money that are attributable to time have severe environmental impact since it forces users of the global monetary system to earn additional money as soon as possible to pay usually external interest earning operators, whilst forcing economic choices to a shorter time scale which often have an ecological damaging impact.

In a typical purchase transaction, a small enterprise would be required to pay for such purchases or orders within 30 or fewer days, while the larger entities extend these due dates up to 90 days from date of invoice. A small enterprise that serves or supplies to a large one is typically at a disadvantage of being required to pay within 30 days but waiting to be paid within 90 days. If such smaller entities are without adequate cash flow, the cost of doing business becomes higher than expected.

The awareness of the need to address the interest-based money system has mostly been concentrated on the target to avoid interest-income earnings while the creation of money against interest as a tool to organize mutual trade has sparsely been debated. This invention addresses the opportunity of creating an interest-free system of exchange, replacing interest-bearing money as tool for exchange, while still maintaining a clear relation with monetary values.

There have been efforts to address or overcome the prevalent system of cash outlays by financial houses or other sources that rely on interest payments for the transactions that bridge the gap between supply or service and payments. These efforts include barter systems, adjustments and more, which have proven to be of limited effectiveness. Thus, the need to apply a means of exchange for enterprises, especially the smaller ones, that is less dependent on ownership of money or the capacity to attract interest out of the market still persists and is addressed by this invention.

### SUMMARY OF THE INVENTION

This invention introduces a novel private payment system that is substantially compatible with money and can compete with monetary transactions in favour of the users. This disclosure preferably includes a method of organizing commerce through administrative records based on future claims on money. It is also an objective of this invention to provide opportunities to trading parties or communities, in a process that provides capacity to efficiently engage in commerce. This invention also facilitates the non-reliance on the price of money (interest) but solely by the risks involved in securing the claims according to monetary value.

Another aim of this disclosure is to obviate the need for cash in communities or expensive credit in order to allow economic actors to optimally engage more with each other in the current global monetary system.

Another objective of the present invention includes the introduction of a system or means to motivate or entice participating individuals or entities to exchange money for value claims without jeopardizing the system and to allow the exchange vice versa.

The present invention further includes a method of managing the money-replacing value claims system wherein the age or use of the claims as units of exchange can be monitored. It also provides tools to swap costs from those that need a credit to those that profit off the purchasing power initiated by that credit. The present invention also stimulates in a specific area for a specific time or use in order to optimize the output of that area, local or national economy.

### DETAILED DESCRIPTION OF THE INVENTION

The purpose of this invention is to provide a new private payment system that can be made wholly compatible with money. The present system preferably uses money as a measure of value while substantially bypassing the costs of money. This invention also preferably includes a method of organizing commerce through an administrative system based on future claims on money. It is one objective of this invention to preferably replace money with a system in which payments are settled with transfer of standardized value claims.

Through restoring economic depreciation above financial calculations it also opts to contribute to the environmental needs.

In an embodiment of the present invention, a transaction claim is preferably established when a claim belonging to an individual or entity is secured by bank or other credible or reliable guarantees or guarantee-issuers. This claim becomes a standard transaction claim that provides security and resources to trading parties or communities. The use of such claims preferably provides a system wherein such value claims can be made on a non-interested party after the initial transactions have occurred. A non-interested party is a party that is not directly involved in the transaction between the supplier or purchaser and buyer. Claims are towards specific legal entities that are secured by a recognized financial institution or by at least a reputable insurance company.

As an example, a participant in the system of the present invention provides a secured instrument, a claim, wherein such a claim or instrument may be based on a future payment promise for the supply of or provision of goods or services to a beneficiary.

A beneficiary, such as a purchaser, according to the present invention may be an entity or an individual who receives value in money, in services or in goods from a supplier and has an obligation to pay for these within a specified period of time. Such obligation creates an indebtedness that may be satisfied by cash payment or as typically the case in business, a future claim in favour of the supplier. It is reasonable to expect businesses to delay the payment for these types of services between 30 and 90 days, if not longer. It is further reasonable to assume that the supplier of such goods or services may need to be paid sooner than later. In most instances, such supplier would likely need financing to meet his or her cost, or to generate some revenue for the continuation of the business immediately after the delivery of the goods or services. It is this cost of financing that attracts interest or other costs and in the present financial circumstances, may prevent some entities from continuing in business at worst, or cause hardships for the supplier, in the least.

The system of the present invention provides a means to bridge the gap between the moment of delivery of goods or services and the money actually being available for the payment or to overcome such issues that may be caused by the lack or absence of funding between orders and payment. A purchaser obtains insurance or payment guarantees upon the generation of a marketable invoice by a supplier based on the supply of goods or services. In the case the purchaser is a financial institution it supplies cash or purchasing power within the system based on a repayment obligation in money.

The insurance, payment or payment guarantees according the present invention may be based on requirements or standards determined by a third party financial facility. In most instances, this insurance or guarantee is based on a specific future payment promise that may have a due or maturity date. The user of the present system that wants to obtain internal purchasing power presents the guarantee to the administrative system as a registrant for a marketable standardized value claim according to the present invention. The obligation to pay at maturity day thus swaps from the individual to the facility.

The owner of standardized value claim of the present invention may present the claim to the supplier who, upon registration with the administrative system of the present invention, will get this value on his/her account. The standardized value claims on that account can be cashed when allowable, or used to conduct commerce within the administrative system of the present invention. It is reasonable for the supplier of the first instance to utilize his or her standardized value claim for the purchase of goods and services from yet another supplier who, by virtue of being part of the system, may convert this claim to cash when allowable, if needed. Suppliers and purchasers can maintain the use of these claims in their marketplace without the generation of cash. As these claims circulate within the system, the need to borrow cash or approach financial institutions for bridge funding may be minimized or eliminated, thus providing a system that is substantially compatible with money yet eliminating most of the cost of capital for the parties.

The system of the present invention also may introduce some principles and rules to encourage or regulate the circulation of these value claims as well as motivation for the use of these claims to avoid the accumulation of claims within an entity—such would be detrimental to the system but may benefit a member or registrant with resources at the expense of the whole system. To address this potential imbalance, the present invention may include a means to encourage commerce by the application of revenue generators or costs to those who may desire to slow down the circulation of standardized value claims. Such principles, according to the present invention include costs for those users of the system that prefer cash to claims. When the claims are based on guarantees that are not yet cashed, the cashing of the claims will generate the costs of attracting the cash. It is preferable that these costs are transparent and previously known to all users of the system. These costs should cover at least the costs of providing the cash but can also be used as an instrument to keep the purchasing power circulating longer in the system. These costs might vary depending on age or use based on the present invention that allows ranking for the duration or use of value claims within the system. The ranking can be used to evaluate charges (diminishing malus) and provide options for combining costs, ranking, age and more.

The administrative system of the present invention also is adaptable for use by financial institutions such as banks, insurance companies, brokerage houses, and the like.

The system of the present invention may present a collection, or all of the original values the standardized claims are based on for deposit in a participating or contracted financial institution. Upon redemption of these original claims, that institution may provide new immediate cashable claims to the system or cash for those who have needs that cannot be met by exchange of claims.

It can further be noted that standardized or original claims are valued as cash for the participants in the system and claims for those who do not have that immediate need. One advantage of this system is the extension of time before cash is needed within the system. It also provides a means to deliver sufficient certainty of the availability of cash to be available to those who need cash. If the system does not have such a contracted partner, cash might only be available when cash comes in. This can be distributed towards the holders of standardized claims in many ways, such as, in a time sequence, based on age or use, through an auction in which the ones that make the highest bid over the nominated value take it, while the system uses this additional income to borrow cash and extend the auction.

Another advantage of the present invention is the encouragement of commerce and catalyses of employment by the extension of liquidity in the market place. As a supplier does not have to be enamoured with the need for immediate cash flow, such supplier or employer may keep his or her sights focused on production of goods and services, thus an avenue to grow the business and maintain employment in the small businesses which are known to be the largest employer of labour. Thus, this invention provides resources to reduce unemployment

In another embodiment of the present invention, the administrative system may be utilized by workers in the transfer of resources to their home families wherever they may be. A remittance may be made within the system for a family member who receives value claims that are acceptable within the system. Each remitter may be rewarded with a bonus for using the system and as an encouragement. The recipient utilizes the funds remitted in a value claim within the system or might request cash against certain costs. These costs that may be charged for any cash or non-system use may be at least as high as the bonus and a value targeted to encourage purchasing within the system and community.

The present invention includes a method of managing the standard transactional value claims system in such a way that the age of the claims, and quantity of times these values have been used for transactions in the system, can be monitored. The innovative approach provides information that can be used to impose specific rules on the participants and most especially those that want to exchange standard transaction claims for money. This invention allows, for example, a government to introduce purchasing power in the circuit and establish rules that assure purchasing power will circulate a defined quantity of times in the area where it is needed or where the circuit is functioning in. It is recognizable that this invention-allows the stimulation of specific area, while the purchasing power will be easily transferable to cash that allows free trade all around the world.

The present invention preferably includes a method of reinsuring the value of the circulating claims in order to allow users of the system to accurately determine the monetary value of the standard claims they own in the system. In this system, standard claims in the system are preferably backed by a guarantee from a suitable financial institution to pay the underlying value under any circumstances on a particular date.

This invention also preferably includes a method of organizing commerce through administrative records based on future claims on money. It is one objective of this invention to preferably substantially replace money in a system with standard value claims, utilizing such claims to provide resources to trading parties or communities, and preferably providing a system wherein such standard value claims can be created on a cost base bypassing the otherwise required cost of interest.

In order to provide a trustable system, the promises against which the internal units of account are being exchanged need to be secured. Since the costs of bank guarantees or insurance of claims, such as bills, are less then the interest banks demand for cash, the system offers an excellent alternative to diminish the costs of trading processes. Through this system future cash can become an effective means of trade, liberating entrepreneurs and communities of the need to pay interest to get the means to administrate mutual transactions.

In another embodiment of the present invention, a system for managing exchange of standardized transaction values preferably includes at least the following paths or options to create a value claim. These paths may be created independently or in combination with other suitable paths. Some of the paths include:
deposition of funds by users potentially attracted by bonus to buy standard value claims;
deposition of payment promises at a specific moment in time secured by banks or big insurance companies; and
Any other claim on future cash that has been properly secured.

In the present invention the ownership of the individual claims that are at the base of the claims circulating within the claim management system can reside with the financial institution that guarantees payment to the claim management system. In that case holders of claims within the claim management structure have to negotiate the option of selling their standard claims for money with that financial institution. The information provided by the claim-management system will be input for that institution to use for cost calculation.

In another exemplary of the present invention, a private claim is owned by the entity that runs the claim management system. The rights to payments by the financial institution that guarantees the payment of the claim is owned by the claim management system. In that case the holders of standard transaction claims within the claim management system can request conversion of that entity at the entity that runs the claim management system. The entity in the present invention may allow these according to the established process and procedures. Where there are costs or charges, such costs or charges are at least the costs a contracted financial institution may claim to pre-finance the cash at the moment the cash is needed. This provides the option that when less than optimal amount in cash is available, the entity can promise cash payment in exchange for standard transaction claims.

Unlike a barter system, the claim management system of the present invention is purposefully supported by guarantees denominated in currency or in specific instances by available currency itself.

In the more advanced systems in which the ‘age’ or ‘use’ of the transaction claims in circulation is being measured, these cost might depend on either the average age or the quantity of times the transaction claims have been used to facilitate trade inside the system.

The system of the present invention also provides a means to increase revenue by charging a fee or tax when a user redeems his or her value claim. This process allows for a conversion-fee (or Malus) to be charged when the transaction occurs or accrued on the respective ledgers. This charge has the benefit to rearrange preferences towards not cashing but exchanging it for goods or services produced inside the system.

Another aspect of the process of the claim management system is a means wherein transaction with the value claims can be stimulated. The system knows the option to introduce an interim bonus that awards either the buyer or the supplier in a specific position in the productive chain with a percentage additional value claims. When a participant in the present system executes a transaction, whether that transaction is adding to the balance sheet or subtracting, an incentive may be provided to encourage such for the collective benefit of the system.

The administrative or management system of the present invention may also provide a process for ranking transactions within the system. Such rankings may be used to determine or assign categories or order to the users of the system. As an example, there may be a process to rank order depositors who have either by time or quantity of transactions impacted positively or negatively, the strength of the system. Other exemplary opportunities include ranking the value claims in terms of time related to the time that the claim may be paid by the administrative system and for the period of time that has elapsed. The ranking can be used to allow specific rules, also for conversion of value claims in the system to cash.

As an explication of an embodiment of the present invention that provides liquidity in the market place, a user in claim management system of the present invention may be a purchaser who is supplied with some value. The purchaser may be an individual, business entity, non-profit corporation, municipality, local government or any other structured facility with the capacity to make a payment promise backed by a guarantee of an appropriate institution. Such purchaser may claim domicile in any location and is not limited to form or substance.

In the case the purchaser bought the claims in an administrative system with cash, this money is available for those that want to convert their claims to money, and for paying the costs. The process of conversion can actually be executed by the administration of the system or be transferred to a financial institution through a contract. Such financial institution according to the present invention includes, but is not limited to a bank, insurance company, investment house, broker or any other facility with the capacity to maintain and retire such deposits with minimal risk to the management system or the users of the system.

A ranking system may be created by the administrative system for the management of the funds. Such ranking system may include means for upgrading, degrading, incentivising or discouraging operations in the management system. A ranking system for transfers in the administrative system may include transactions C or fines or taxes M which become the revenue source for the system as well as an instrument to guide the purchasing power. C ranking relates to a claim position after each claim has been processed. It is upgraded or ranked as a user makes a transfer within the claim management system of the present invention. An M ranking is a conversion fee or tax or fine that may be levied for conversions or claims within the system that is denoted to attract a fee, tax or fine. An exemplary mathematical model for generation of ranking and revenue is included in Equations I-XXXVI of Appendix A.

The present invention includes exemplary mathematical models for incorporating relationships between balances, transactions, ranking and age of the funds used in of the present invention. The relationships between balances, transaction, ranking and time that can be used to offer incentives or apply costs that allow a smooth functioning or specific targets

In an embodiment of the present invention, liquidity in the market place is introduced as value claims, and may be used as such within the management system. Upon the need for cash, the holder of a value claim may exchange for value with another consumer in the system as determined by the claims management system.

The risks to the management system or the users of the system may preferably be backed by guarantees from any entity with capacity to deliver same or from the financial institution of the present invention.

The management system of the present invention thus preferably provides a method of adding time to cash available for commerce and can be used to facilitate exchange in locations of low economic capacity without the challenges of the current economic disposition that favours disbursement of funds in locations of high economic capacity. The present invention also provides a means to increase the availability of economic capacity as a stimulus for stagnant economic conditions without the introduction of money as a primary input.

While the descriptions according to the present invention provide embodiments according to the management system, it is not all inclusive and is recognized that any one skilled in the art to which this pertains may introduce modifications or variations based on the present invention. Such modifications or variations as are obvious to one skilled in this art are included in the teaching of the present invention.

### APPENDIX A

### Sample Equations Used in Ranking Calculations. C-Ranking Model

Formulas of the General Mathematical Model for Diminishing Malus with C-Ranking

For upgrading the C-ranking when a transfer occurs, so when a set of claims is taken from an account:

A general form is:

Cᵢ=f(i) Eq. 1

Where in every variation:
Cᵢ is the new C-ranking after the i^{th} transaction which the set of claims has gone through.
f( ) is a function of i. In formula:

(i)<0 for all relevant i.

In the below formulas:
C is the C-rank
M is the malus

The general relation is:

M=g(C) Eq. II

So for positive slopes:

g′(C)>=0 Eq. III

### Diminishing Malus: D-Ranking Model.

D-ranking pertains to the daily decrease counter, which is the number of days until expiration of guarantee. Typical formulas of the general mathematical model for diminishing malus with D-ranking include:

A general form is:

Dᵢ=f(i) Eq. IV

Where in every variation:
Dᵢ is the new D-ranking at days i.
f( ) is a function of i.

f′(i)<0 for all relevant i.

In the below formulas:
D is the D-rank
M is the malus

The general relation is:

M=g(D) Eq. V

A constraint to function g is that it must be positively sloping. So:

g′(D)>=0 Eq. VI

So the converter gets amount $ for his units which originally had value L is the original amount of the loan, D is the days, as such that $+interest over D days=L.

L=$(1+R)^{D} Eq. VII

Where:
L is the value of the claim, equaling the guarantee payment coming in at day D=0
$ is the resulting amount from conversion for the client
R is the present market interest rate, (re)calculated on a daily basis.
D is the number of days until the guarantee expires. In most cases, this is the D-ranking value, in case the D-ranking has a 1:1 relationship with the remaining days until expiry.

As the Malus M eauals (L−$)/L, it follows that the malus must at least be

$$M >= 1 - \frac{1}{{( 1 + R )}^{D}} \qquad Eq . VIII$$

for the organization to be financially viable.

This means that the formula depends on the general function g describing the relation between malus and D (see above):

M=g(D)

For the merged claim, the following applies, as defined:

M=g(D_{merged})=L_{merged}−$_{merged} Eq. IX

From this we can simply derive the general formula for D

D_{merged}=g⁻¹[g(D₁)+g(D₂)] Eq. X

In this, the values of

Where:
D_{merged} is the D-ranking of the merged set of claims
g⁻¹ is the inverse function of g; g is the function describing the relationship between Malus M and D-ranking D
D₁ and D₂ are the values for the D-ranking of the two sets of claims to be merged

### Age Counter and Conversion Tax: A-Rate Model.

A-rate model relates to an age index counter, representing time since the creation of such unit. Formulas of the general mathematical model of A-ranking include:

A general form is:

Aᵢ=f(i) Eq. XI

Where in every variation:
Aᵢ is the new A-ranking at day i.
f( ) is a function of i.

f′(i)>0 for all relevant i.

In the below formulas:
A is the A-ranking
F is the early converstion tax percentage

The general relation is:

F=g(A)

A constraint to function g is that it must be negatively sloping. So:

g′(A)<=0 Eq. XII

### Relation Between C and M

The relation between C and M is simply linear. Using the simple technique of linear conversion gives the formula:

$$M = \frac{C ( {M}_{1} - {M}_{m i n} ) + {M}_{m i n} {C}_{1}}{{C}_{1}} \qquad Eq . XIII$$

The formula can be inverted:

$$C = \frac{{C}_{1} ( M - {M}_{ m i n} )}{{M}_{1} - {M}_{ m i n}} \qquad Eq . XIV$$

C-Rankings for Transferred Value Claims:

For this, the next menu should be followed.
1. First, determine the C-ranking of the payer. From this, we will calculate which i would belong to this.
2. If C_{payer}>C_{S1}, then the following applies:

$$i = \frac{- g - √ ( g 2 - 4 f ( h - {C}_{payer} ) )}{2 f} \qquad Eq . XV$$

This is the first solution according to the general solution of a quadratic function.
3. If C_{payer}<C_{S1}, and C_{payer}>C_{S2}, the following applies:

$$i = {S}_{1} + \frac{n {C}_{S 1} - {nC}_{payer}}{{C}_{1}} \qquad Eq . XVI$$

4. If C_{payer}<C_{S2}, the following applies:

$$i = \frac{1 - r ( {C}_{payer} - p )}{q ( {C}_{payer} - p )}$$

5. Now we have calculated the i, we will just add 1 to it. So i=i+1.
6. This entry of i we just enter into one of the formulas:
   a. If i<S₁ we use the formula describing the quadratic section, with f, g and h as parameters.
b. If i between S₁ and S₂ we use the formula describing the linear section, with a and b as parameters.
c. If i>S₂ we use the formula describing the asymptotic section, with p, q and r as parameters.

### Transaction Tax Formulas

To retrieve enough revenues from a transaction tax, the following should hold:

$${T}_{i} = \frac{{M}_{i - 1} - {M}_{i}}{1 - {M}_{i}} \qquad Eq . XVIII$$

where
Tᵢ is the transaction tax percentage
Mᵢ₋₁ is the malus percentage following from the C-ranking of the payer before the transaction was applied
Mᵢ is the new malus percentage following from the new C-ranking after the transaction was applied.

Each incoming transaction generates C-points, basically:

C-Points transaction=Amount×C-ranking
where C-ranking is the new C-ranking calculated from the C-ranking of the payer as described in the previous sections.

P=Σ(IC) Eq. XIX

Pᵢ=Pᵢ₋₁+(IC) Eq. XX

If the present transaction is an outgoing transaction, then:

Pᵢ=Pᵢ₋₁−(OC) Eq. XXI

where O is the outgoing transaction, and C is the present C-ranking. Note that the C-ranking does not change; both new sets get the same C-ranking. The only thing which changes is the C-Points balance of the set of claims which is remaining on the account.

For retrieving C from P we should divide by the balance B=ΣI−ΣO

C=Pᵢ/B Eq. XXII

The formula for this can be deduced analogous to the previous section formulas.

$$A = B \frac{{M}_{0} - {M}_{1}}{1 - {M}_{1}} \qquad Eq . XXIII$$

where:
A=the amount to be paid
B=the present balance
M₀=the present malus
M₁=the malus wished for
Or, in inverted form:

$${M}_{1} = \frac{{BM}_{0} - A}{B - A } \qquad Eq . XXIV$$

In formula:

Dᵢ=Dᵢ₋₁−1 Eq. XXV

### Where:

Dᵢ is the D-ranking at day i
Dᵢ₋₁ is the D-ranking at day i−1 (the previous day)

When converting a claim in local units to national currency, the following formula applies:

$$\$ = \frac{L ( 1 - {M}_{0} )}{{( 1 + r )}^{D}} \qquad Eq . XXVI$$

The amount of malus paid is of course equal to L−$.

The asymptotic part of the curve (for D<d) is subject to the following formula.

$$\$ = c + \frac{1}{( aD ) + b} for any D < d \qquad Eq . XXVII$$

Where the parameters are as follows:

$$\begin{matrix}a = \frac{K ln ( 1 + R )}{{( K - c )}^{2}} & Eq . XXVIII \\ b = \frac{1}{K - c} - ad \\ c = {\$}_{ma x} & Eq . XXIX \\ K = \frac{L ( 1 - {M}_{0} )}{{( 1 + R )}^{D}} & Eq . XXX\end{matrix}$$

When two sets of claims come together on one account, for example in the case of an incoming payment, the following applies:

### Determining the A-Ranking

For each account balance, a creation date field E is stored. Always, it counts that:

$${D}_{sum} = \frac{ln ( {L}_{1} + {L}_{2} ) + ln ( 1 - {M}_{0} ) - ln ( {\$}_{1} + {\$}_{2} )}{ln ( 1 + R )} \\ A = E - present date \qquad Eq . XXXI$$

In formula:

$${E}_{new} = \frac{{B}_{1} {E}_{1} + {B}_{2} {E}_{2}}{{B}_{1} + {B}_{2}} \qquad Eq . XXXII$$

The general formula for an asymptotic relation applies:

$$F = p + \frac{1}{qA + r } \qquad Eq . XXXIII$$

Parameters p, q and r resolve to:

$$\begin{matrix}p = {F}_{∞} & Eq . XXXIV \\ q = \frac{- H}{{A}_{F = 0} {F}_{∞} ( H - {F}_{∞} )} & Eq . XXXV \\ r = 1 / ( H - {F}_{∞} ) & Eq . XXXVI\end{matrix}$$

What is claimed is:

1. A system for introducing liquidity in the market place, comprising:
a provision of value to a consumer, and generation of an invoice;
a securitization of the invoice by the consumer, wherein said securitization becomes a standardized value claim for the provider of value, and wherein said claim is redeemable as a guarantee for payment of the invoice;
a utilization of the claim for commercial purposes within a network, wherein said utilization minimizes the use of cash within the network and provides an alternate means of payment while being substantially compatible with cash and forming a standardized internal means of payment.

2. The system of claim 1, wherein the participants are part of an established network.

3. The system of claim 1, wherein securitization may be provided by a non-interested third party.

4. The system of claim 1, wherein the securitization is provided from a group selected from banks, insurance companies, brokerage houses, investors or combination thereof.

5. The system of claim 1, wherein the invoice is generated by the consumer.

6. The system of claim 1, wherein the redemption is executed by the supplier for cash or goods and services.

7. The system of claim 1, wherein the procurement of a standardized value claim is rewarded with a bonus.

8. The system of claim 1, wherein claims are generated by commitments to deposit funds in the future.

9. The system of claim 8, wherein claims on payments of money offered are guaranteed

10. The system of claim 1, wherein the holders of standardized value claims pay a malus when they want to collect cash.

11. The system of claim 1, wherein the owners of a positive account of standardized value claims can allow others to use the account for his or her benefit.

12. The system of claim 1, wherein the parties are not in the same country or jurisdiction.

13. The system of claim 1, wherein a bonus is calculated for incentives by ranking.

14. The system of claim 1, wherein a fee is incorporated as part of the encouragement for the claim management system users.

15. The system of claim 1, wherein the age of the claim is used to calculate a conversion fee for the consumer.

16. The system of claim 15, wherein a malus is established via relationship that is selected from the group consisting of costs, ranking, transactions, age of claims, or combination thereof.

17. A system for introducing liquidity in the market place, comprising:
a payment process based on future claims on money, further comprising;
depositing funds by a first user of the process;
creating a standardized value claim based on the funds deposited, wherein the depository is a financial institution;
providing the standardized value claim to a second user of the process,
wherein said second user utilizes the value claim for subsequent purchase within the claim management system, and wherein the use of the value claims extends the availability of funds in the market place without actual cash.

18. The system of claim 17, wherein the funds are secured by a third party.
